(19) United States
(12) Patent Application Publication
(10) Pub. No.: US 2011/0145154 A1
(43) Pub. Date: Jun. 16, 2011

(54) Policy Development Criticality And Complexity Ratings

(75) Inventors: Angela Smith Rivers, Harrisburg, NC (US); Joyce Afriyie, Stallings, NC (US)

(73) Assignee: BANK OF AMERICA CORPORATION, Charlotte, NC (US)

(21) Appl. No.: 12/635,276

(22) Filed: Dec. 10, 2009

(51) Int. Cl. G06Q 10/00; G06F 17/30

(52) U.S. Cl. 705/301; 707/758; 705/348; 707/E17.009

(57) ABSTRACT

Methods, computer readable media, and apparatuses for policy development and management are presented. One or more policy needs may be identified, and a criticality rating and a complexity rating may be determined for each policy need. The criticality rating and the complexity rating may be based on one or more weighted criticality and complexity factors. The criticality rating may affect prioritization of policy development, and the complexity rating may affect an estimate of time required for policy development. Subsequently, a report may be generated.

### BACKGROUND

Within an organization, such as a financial institution, various policies may be developed, implemented, and managed to bring the organization into compliance with laws, regulations, ethical standards, internal guidelines, and other rules. In many organizations, however, limitations on resources and other considerations require decisions to be made about which policies should be developed, implemented, and managed, and which policies should not be. For the organization to make optimal decisions about policy development, implementation, and management, it thus may be preferable to measure policies and policy needs against one or more uniform standards.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure relate to policy development and management. According to one or more aspects, a development criticality and complexity rating may be determined for a policy need. Input may be received, and the input may correspond to a first policy need. Subsequently, a development criticality rating for the first policy need may be determined based on whether the first policy need implicates an audit issue and/or based on whether the first policy need implicates a compliance issue. Thereafter, a development complexity rating for the first policy need may be determined based on a level of involvement required to develop the first policy need. Then, a report may be generated, and the report may include the determined development criticality rating for the first policy need and the determined development complexity rating for the first policy need.

### BRIEF DESCRIPTION OF THE DRAWINGS

The present disclosure is illustrated by way of example and not limited in the accompanying figures in which like reference numerals indicate similar elements.

FIG. 1A illustrates a suitable operating environment in which various aspects of the disclosure may be implemented.

FIG. 1B illustrates a suitable system in which various aspects of the disclosure may be implemented.

FIG. 2 illustrates a suitable network environment in which various aspects of the disclosure may be implemented.

FIG. 3 illustrates a method by which one or more policy needs may be assessed according to one or more aspects described herein.

FIG. 4 illustrates a sample user interface through which one or more policy needs may be assessed according to one or more aspects described herein.

FIG. 5 illustrates a method by which a criticality rating and a complexity rating may be determined for a policy need according to one or more aspects described herein.

FIG. 6A illustrates a sample user interface through which a criticality rating may be determined for a policy need according to one or more aspects described herein.

FIG. 6B illustrates a sample user interface through which a complexity rating may be determined for a policy need according to one or more aspects described herein.

FIG. 7 illustrates a sample user interface in which a complexity rating may be correlated with a development time for a policy need according to one or more aspects described herein.

FIG. 8 illustrates a sample user interface in which a criticality rating and a complexity rating of a policy need may be compared according to one or more aspects described herein.

FIG. 9 illustrates a sample user interface in which a criticality rating and a complexity rating of one or more policy needs may be compared according to one or more aspects described herein.

FIG. 10 illustrates a method by which an adherence rating and an effectiveness rating may be determined for a policy according to one or more aspects described herein.

FIG. 11A illustrates a sample user interface through which an adherence rating may be determined for a policy according to one or more aspects described herein.

FIG. 11B illustrates a sample user interface through which a responsiveness rating may be determined for a policy according to one or more aspects described herein.

FIG. 11C illustrates a sample user interface through which a business operational impact rating may be determined for a policy according to one or more aspects described herein.

FIG. 11D illustrates a sample user interface through which a compliance rating may be determined for a policy according to one or more aspects described herein.

FIG. 12 illustrates a sample user interface through which one or more policies may be compared according to one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

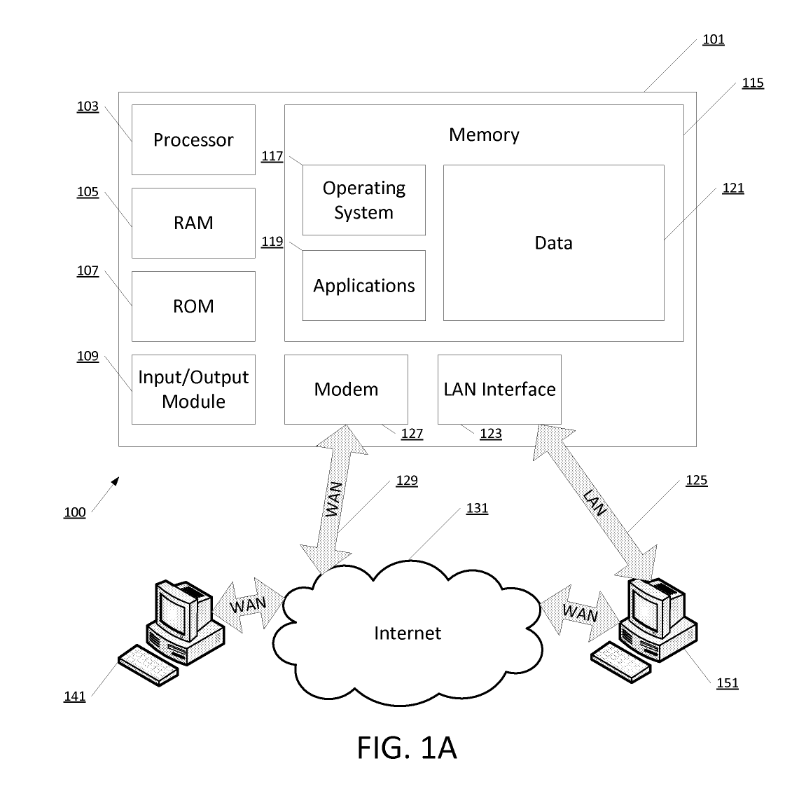

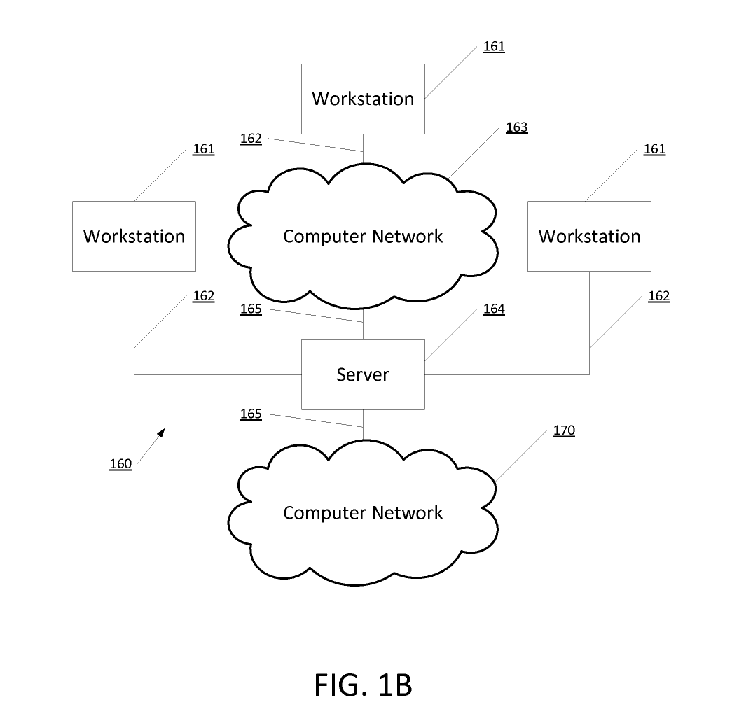

FIG. 1A illustrates a block diagram of a generic computing device 101 (e.g., a computer server) in computing environment 100 that may be used according to one or more illustrative embodiments of the disclosure. The computer server 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual, and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of the computer executable instructions for server 101 may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates a suitable system 160 in which various aspects of the disclosure may be implemented. As illustrated, system 160 may include one or more workstations 161. Workstations 161 may be local or remote, and may be connected by one or communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

Computer network 163 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 162 and 165 may be any communications links suitable for communicating between workstations 161 and server 164, such as network links, dial-up links, wireless links, hard-wired links, etc.

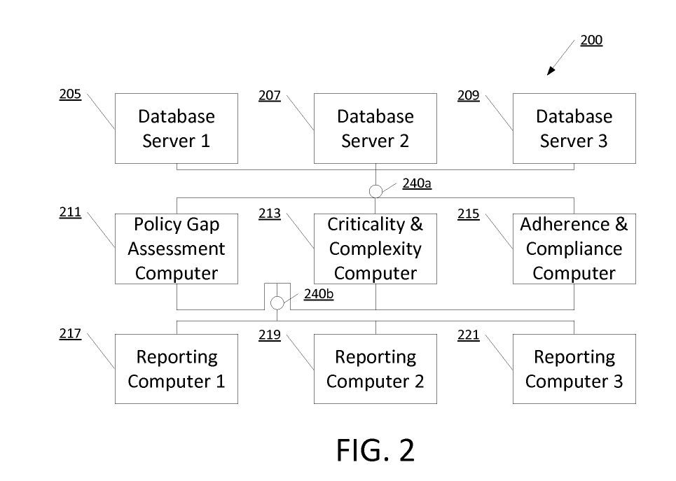

FIG. 2 illustrates a suitable network environment in which various aspects of the disclosure may be implemented. Network environment 200 may include several computing devices. For example, network environment 200 may include one or more database servers, such as database servers 205, 207, and 209. In one or more arrangements, one or more of database servers 205, 207, and 209 may store information about one or more policy needs, one or more implemented policies, and/or one or more development resources. For example, database server 205 may store information about the current workload and/or capacity of one or more policy development resources.

Network environment 200 further may include policy gap assessment computer 211, criticality and complexity computer 213, and adherence and compliance computer 215. In one or more configurations, policy gap assessment computer 211 may perform a method by which one or more policy needs may be assessed, as further described herein. In one or more additional configurations, criticality and complexity computer 213 may perform a method by which a criticality rating and a complexity rating may be determined for a policy need, as further described herein. In one or more additional configurations, adherence and compliance computer 215 may perform a method by which an adherence rating and an effectiveness rating may be determined for a policy, as further described herein.

Network hubs, such as network hubs 240a and 240b, may be used to connect various computers in network environment 200. For example, network hub 240a may be used to connect one or more of database servers 205, 207, and 209 with policy gap assessment computer 211, criticality and complexity computer 213, and/or adherence and compliance computer 215.

Network environment 200 further may include one or more reporting computers, such as reporting computers 217, 219, and 221. In one or more arrangements, one or more of reporting computers 217, 219, and 221 may generate one or more reports in which source data, computed results, and/or charts and graphs are presented. Additionally or alternatively, one or more of reporting computers 217, 219, and 221 may store source data, computed results, and/or charts and graphs in a database to enable internal and/or external customer access to information. For example, reporting computer 217 may generate a report and/or store information in a database that includes the results of a method by which one or more policy needs may be assessed. In another example, reporting computer 219 may generate a report and/or store information in a database that includes the results of a method by which a criticality rating and/or a complexity rating may be determined for a policy need. In another example, reporting computer 221 may generate a report and/or store information in a database that includes the results of a method by which an adherence rating and/or an effectiveness rating may be determined for a policy.

While network environment 200 is described as including various computers adapted to perform various functions, it should be understood that the system may be modified to include a greater or lesser number of computers which may be used alone or in combination to provide the same functionality. For example, a single computer may be used to perform all of the functions described, and one or more users may interact with the single computer through one or more terminals and/or user interfaces. In another example, a first computer may be used to perform all of the functions of database servers 205, 207, and 209, a second computer may be used to perform all of the functions of policy gap assessment computer 211, criticality and complexity computer 213, and adherence and compliance computer 215, and a third computer may be used to perform all of the functions of reporting computers 217, 219, and 221.

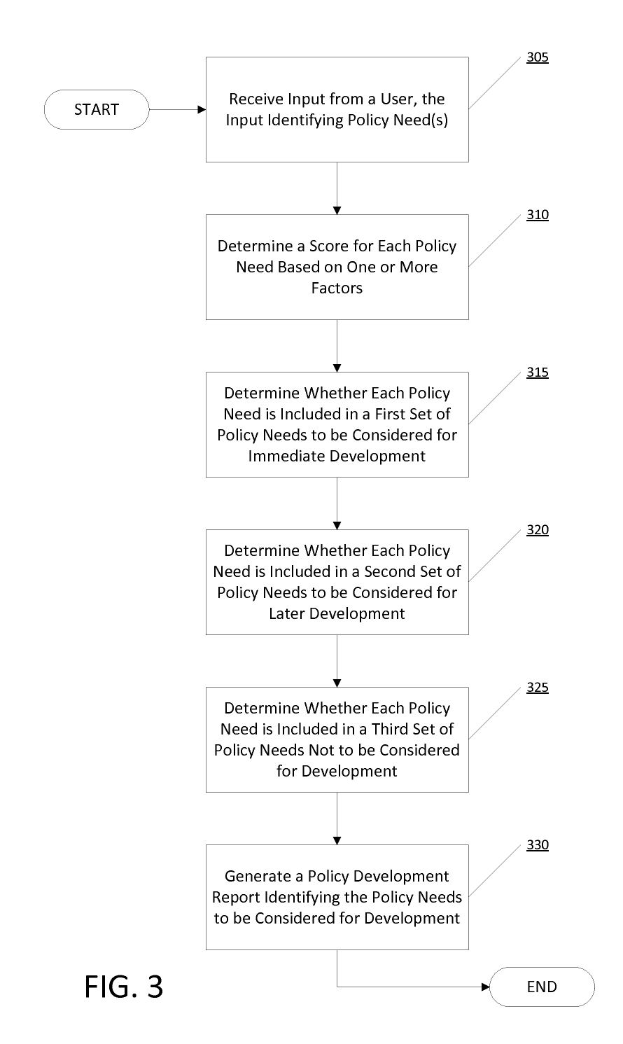

FIG. 3 illustrates a method by which one or more policy needs may be assessed according to one or more aspects described herein. According to one or more aspects, the methods described herein may be implemented by software executed on one or more computers, such as computing device 101, and/or in a network environment, such as network environment 200.

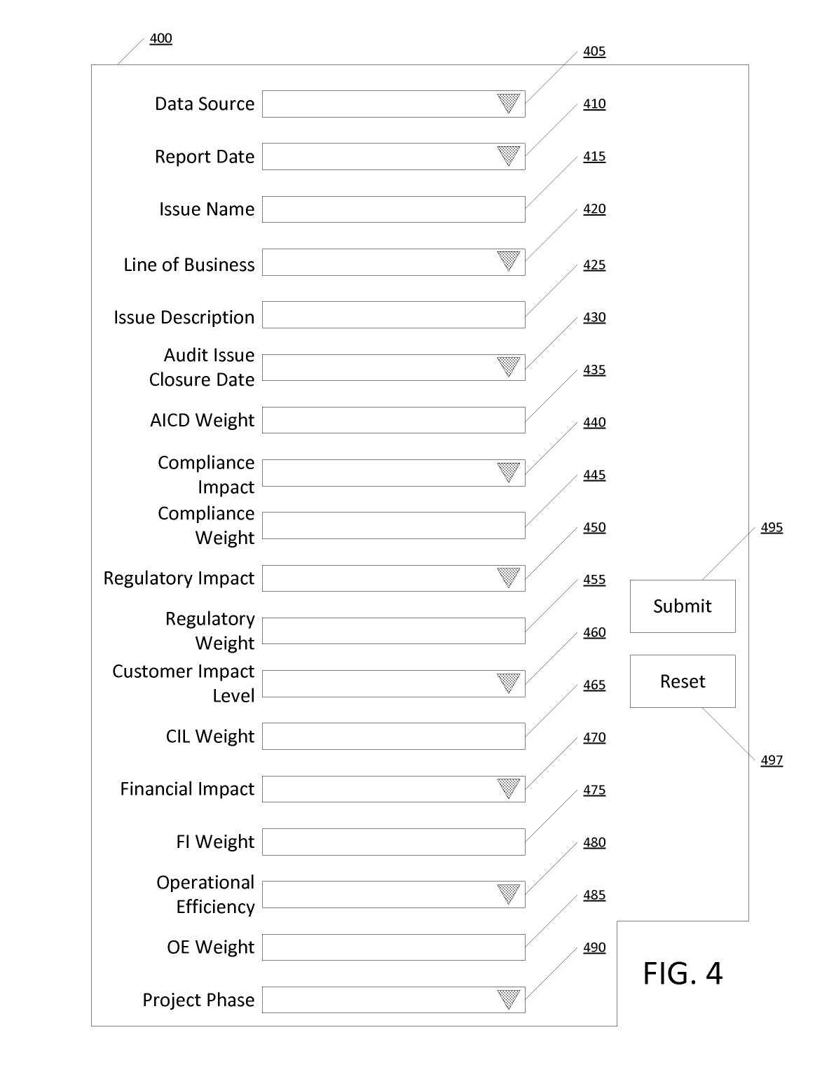

In step 305, input may be received from a user, and the input may identify one or more policy needs. Additionally or alternatively, data may be extracted and/or received from one or more external databases. For example, input identifying a new policy need to be considered for development may be received via user interface 400, as further described with respect to FIG. 4 below. This input may include an issue name and/or an issue description, and further may include audit issue closure date information, legal compliance information, regulatory impact information, customer severity impact information, financial impact information, and/or operational efficiency information, as further described herein. In addition, one or more external databases may be queried, and stored information, such as development resource workload and/or capacity, may be received in response to such querying.

Additionally or alternatively, any and/or all of the information received as input from a user may be extracted and/or received as stored information from one or more external databases. In a first example, a user may populate all of the various fields in user interface 400, and the populated values subsequently may be received as input into the system. In a second example, a user may populate only some of the various fields in user interface 400, the populated values subsequently may be received as input, and one or more external databases may be queried automatically to retrieve and/or extract other data that may be desired in performing one or more aspects described below. In this second example, user-populated values might include a data source, an issue name, an issue description, and an audit issue closure date, and a system implementing one or more aspects described herein automatically may query one or more external databases to retrieve and/or extract a report date, line of business information, legal compliance impact information, regulatory impact information, customer severity impact information, financial impact information, and/or operational efficiency information. In a third example, a user might not populate any fields in user interface 400, and one or more external databases may be queried automatically to retrieve and/or extract data that may be desired in performing one or more aspects described below. In this third example, a system implementing one or more aspects described herein thus may query automatically one or more external databases to retrieve and/or extract data corresponding to some or all of the fields in user interface 400.

In step 310, a score for each policy need may be determined based on one or more factors. According to one or more aspects, this score determination may be based on audit issue closure date information, legal compliance information, regulatory impact information, customer severity impact information, financial impact information, and/or operational efficiency information. Audit issue closure date information may indicate the amount of time a financial institution has to bring its practices and/or procedures into compliance with a new law or regulation that may be giving rise to a particular policy need. For example, the audit issue closure date information may indicate that a financial institution has less than three months to comply with a new law or regulation, that a financial institution has more than three months to comply with a new law or regulation, that the amount of time for compliance has yet to be determined, or that there is no compliance deadline.

Legal compliance information may indicate the level of potential legal and/or regulatory impact that may result from non-compliance with a law and/or regulation that may be related to a particular policy need. For example, legal compliance information may indicate that the level of potential legal and/or regulatory impact that may result from non-compliance with a new law and/or regulation is “very high,” “high,” “moderate,” “low,” or “very low.” Alternatively, the level of potential legal and/or regulatory impact that may result from non-compliance with a new law and/or regulation may be based on a financial amount. For example, legal compliance information may indicate that the level of potential legal and/or regulatory impact that may result from non-compliance with a new law and/or regulation is “Less than $1 million dollars,” “$1 million dollars to $10 million dollars,” “$10 million dollars to $50 million dollars,” “$50 million dollars to $100 million dollars,” or “More than $100 million dollars,” and these ranges may represent a potential financial penalty imposed in the event of non-compliance. Additionally or alternatively, these ranges may represent a loss amount associated with the cost of legal services and/or the harm to reputation that may result from non-compliance with a new law and/or regulation.

In one arrangement, a system implementing one or more aspects described herein automatically may assess legal compliance information and based on this assessment, may advise against immediate compliance with a law and/or regulation that may be related to a particular policy need. This advice may be based on a cost-benefit assessment in which it might be determined that the level of potential legal and/or regulatory impact that may result from non-compliance with a new law and/or regulation (e.g., a potential penalty) is less than the cost of complying with the new law and/or regulation. Additionally or alternatively, the system may determine that it would be most cost efficient to implement a compliance solution over a longer period of time even though a penalty may be imposed for non-compliance during some or all of time in which the compliance solution may implemented.

For example, if there is a three-month deadline for complying with a particular new law and a monthly penalty of $100,000 is imposed for each month of non-compliance, but the internal cost of complying with the particular new law in three months is at least $200,000 more than complying with the particular new in law in five months, the system may advise that a compliance solution should be implemented over five months even though a two-month non-compliance penalty will be imposed, because the cost of the two-month non-compliance penalty is less than the cost of complying within the shorter time period (i.e., before the three-month deadline for complying with the particular new law).

Additionally or alternatively, the system may be configured to advise multiple courses of action, where a first course of action may be more cost-efficient than a second course of action, but where the second course of action may avoid potential penalties imposed for non-compliance. For example, after performing a cost-benefit assessment, the system may advise taking one of two courses of action, where the first course of action may involve complying with a new law within a defined compliance period to avoid a potential penalty for non-compliance, and where the second course of action may involve complying with the law beyond the defined compliance period, thus incurring the potential penalty for non-compliance, but where the second course of action is more cost effective than the first cost of action because the amount of the potential penalty is less than the cost of complying with the new law within the defined compliance period.

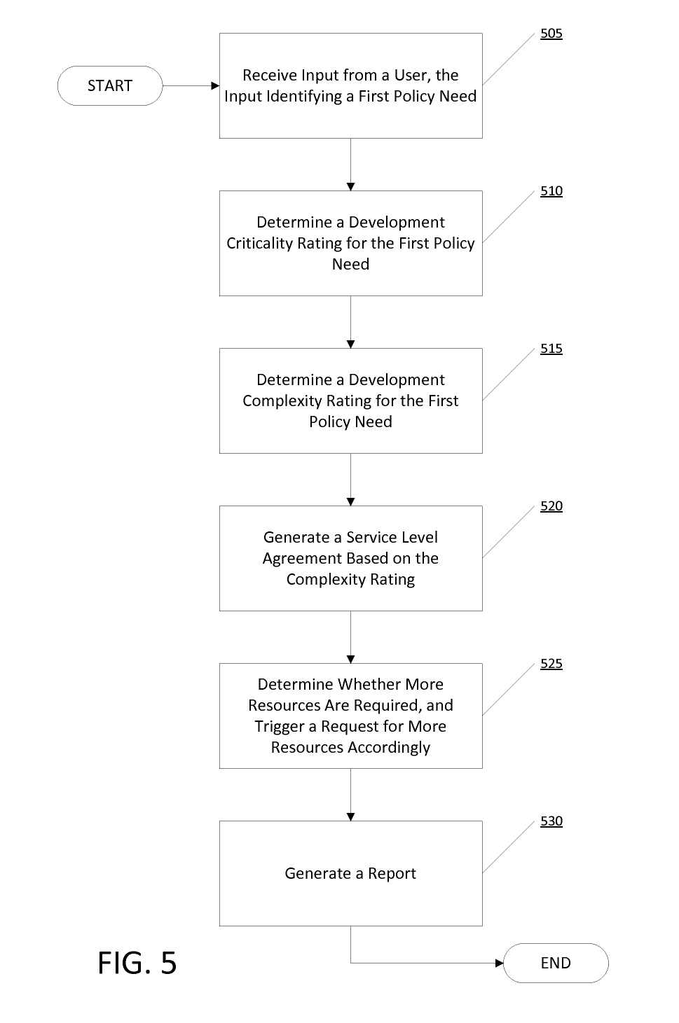

According to one or more additional aspects, a system implementing one or more aspects described herein may be configured to recommend and/or implement various courses of action for any number of other conditions automatically. In one example, the system automatically may determine that more resources are needed to develop and/or implement a policy (as further described with respect to FIG. 5 below and elsewhere herein), may trigger a request for the additional resources, and may estimate a new budget based on the additional resources requested. In this example, the request for additional resources may be specific as to the type of resources (e.g., people, such as temporary workers, computer programmers, and the like, and hardware, such as computers, servers, and the like) and may be specific as to the quantity of resources (e.g., 1 server, 5 computers, 2 computer programmers, and 1 project manager). Further, in this example, the system may estimate the new budget based on the request for additional resources and/or data stored in one or more databases. For example, after triggering the request for additional resources, the system may query and/or extract information from a database, where the database stores cost information about one or more resources. Based on this cost information, the system thus may estimate the budget based on the type and/or quantity of additional resources requested.

In yet another example, the system automatically may take steps to prevent and/or reduce the likelihood of the imposition of a financial penalty for non-compliance with a law and/or regulation. In this example, the system may be configured to take certain actions without user approval and/or input. For example, an entity might not desire to have its public image associated with non-compliance with one or more new laws and/or regulations unless the cost-benefit assessment of short-term non-compliance is above a predetermined threshold. As such, in one configuration, where the system determines that the cost of compliance is below a first threshold and/or that the benefit of compliance is above a second threshold, the system automatically may take steps to implement the policy, for example, by generating one or more purchase orders, resource requisitions, authorization codes, and/or similar requests to facilitate the entity's compliance efforts. For example, in one configuration, if the system determines that the cost of compliance is below $100,000 and/or that the benefit of compliance is positive media attention, then the system automatically may generate purchase orders for computer equipment, resource requisitions for more workers (based on an estimated number of hours needed to develop a policy and/or based on the current availability and/or workload of existing resources), and/or authorization codes (which may be needed to facilitate various aspects of implementation processes for internal approval and/or accounting purposes).

Regulatory impact information may indicate the number of regulations addressed and/or affected by a particular policy need. For example, regulatory impact information may indicate that one, two, three, four, or five or more policies are addressed and/or affected by the particular policy need.

Customer severity impact information may indicate the level of potential impact on a customer experience that may result from non-compliance with a law or regulation. For example, customer severity impact information may indicate that non-compliance with a new law or regulation may result in a “Severity Level 1” impact, a “Severity Level 2” impact, or a “Severity Level 3” impact. According to one or more aspects, a “Severity Level 1” impact may correspond to 5,000 or more failed customer interactions per day; 1,000 or more continuing failed customer interactions per hour; a financial loss of $500,000 or more per day; broken links on a main webpage; and/or any other high visibility issue, such as press coverage, privacy risks, and/or security concerns. A “Severity Level 2” impact may correspond to 1,900 or more failed customer interactions per day; 200 or more continuing failed customer interactions per hour; a financial loss of $100,000 or more per day; and/or a legal, regulatory, audit, and/or contractual issue. A “Severity Level 3” impact may correspond to any other impact which does not fall within the “Severity Level 1” impact or “Severity Level 2” impact classifications.

Financial impact information may indicate the level of potential financial impact that may result from implementing a policy in response to a particular policy need. For example, financial impact information may indicate that the level of potential financial impact that may result from implementing a policy in response to a particular policy need is “very positive,” “positive,” “none,” “negative,” or “very negative.” In another example, financial impact information may indicate that the level of potential financial impact that may result from implementing a policy in response to a particular policy need is “Profit of more than $10 million dollars,” “Profit of $10 million dollars or less,” “No profit or loss,” “Loss of $10 million dollars or less,” or “Loss of more than $10 million dollars.”

Operational efficiency information may indicate the likelihood that a policy responding to a particular policy need will create one or more operational efficiency opportunities. For example, operational efficiency information may indicate that such an outcome is “very likely,” “likely,” “neutral,” “unlikely,” or “very unlikely.” In other words, operational efficiency information may indicate that implementing a particular policy in response to a particular policy need may create opportunities whereby operational efficiency may be improved and/or enhanced. For example, a policy developed and/or implemented in response to a particular policy need may create one or more operational efficiency opportunities by improving the efficiency and/or realization rate of resources, reducing errors in processes, improving the quality and/or timeliness of goods and/or services, reducing the risk of future legal liabilities, and the like.

Thus, determining a score for a policy need may include, for example, assigning a numerical score to each possible classification among the different types of information comprising the basis for the score determination (e.g., “very high” or “very likely” may correspond to a higher score than “very low” or “very unlikely”), determining the applicable score for each type of information based on the selected classification, weighting the applicable scores by multiplying the applicable scores by one or more weights, and summing the weighted numerical scores to arrive at the score for a particular policy need.

For an example policy need where the audit closure date information indicates that a financial institution has less than three months to comply with a particular law or regulation, where the legal compliance information indicates that non-compliance may result in a “very high” impact, where the regulatory impact information indicates that four regulations may be impacted, where the customer severity impact information indicates that non-compliance may result in a “Severity Level 2” impact, where the financial impact information indicates that non-compliance may result in “moderate” financial impact, and where the operational efficiency information indicates that the creation of one or more operational efficiency opportunities is “likely,” the determination may proceed as follows. If each possible classification among the different types of information comprising the basis for the score determination is assigned a number between 1 and 5 for scoring purposes, then in this example, the audit closure date information may correspond to an un-weighted score of 5, the legal compliance information may correspond to an un-weighted score of 5, the regulatory impact information may correspond to an un-weighted score of 4, the customer severity impact information may correspond to an un-weighted score of 3, the financial impact information may correspond to an un-weighted score of 3, and the operational efficiency information may correspond to an un-weighted score of 4.

Further, a weight of 20 may be assigned to the audit issue closure date information, a weight of 15 may be assigned to the legal compliance information, a weight of 10 may be assigned to the regulatory impact information, a weight of 10 may be assigned to customer severity impact information, a weight of 5 may be assigned to financial impact information, and a weight of 1 may be assigned to operational efficiency information. Thus, the score for this example policy need may be determined to be the weighted audit issue closure date information score (5*20) plus the weighted legal compliance information score (5*15) plus the weighted regulatory impact information score (4*10) plus the weighted customer severity impact information score (3*10) plus the weighted financial impact information score (3*5) plus the weighted operational efficiency information score (4*1) or 264 (i.e., the sum total of the weighted scores in this example).

In step 315, it may be determined whether each policy need is included in a first set of policy needs, where the first set of policy needs represents one or more policy needs to be considered for immediate development. According to one or more aspects, this determination may be based on the score for the policy need as determined in step 310. For example, it may be determined that a particular policy need is included in the first set of policy needs because the score for the policy need determined in step 310 exceeds a first threshold (e.g., 200). In this example, the first threshold may be predetermined by an organization implementing one or more aspects described herein. Additionally or alternatively, the first threshold may be determined automatically by a system implementing one or more aspects described herein based on the number of policy needs submitted during a particular time period and a particular percentage of policy needs that is to be allowed and/or developed during the particular time period. For example, if one hundred policy needs were submitted in a week, the system may be configured to set the first threshold such that the top forty percent of policy needs (by score) are above the first threshold. In one or more additional configurations, the particular percentage of policy needs that is to be allowed and/or developed during the particular time period may be determined automatically by the system based on the current workload and/or availability of development resources. For example, the system automatically may raise the first threshold in response to determining that few resources are available, and the system may lower the first threshold in response to determining that many resources are available.

In step 320, it may be determined whether each policy need is included in a second set of policy needs, where the second set of policy needs represents one or more policy needs to be considered for later development. According to one or more aspects, this determination may be based on the score for the policy need as determined in step 310. For example, it may be determined that a particular policy need is included in the second set of policy needs because the score for the policy need determined in step 310 exceeds a second threshold (e.g., 100). According to one aspect, the second threshold may be lower than the first threshold. Like the first threshold, the second threshold may be predetermined by an organization implementing one or more aspects described herein. Additionally or alternatively, the second threshold may be determined automatically by a system implementing one or more aspects described herein based on the number of policy needs submitted during a particular time period and a particular percentage of policy needs that is to be allowed and/or developed during and/or after the particular time period. For example, if one hundred policy needs were submitted in a week, the system may be configured to set the second threshold such that the top seventy percent of policy needs (by score) are above the second threshold. In one or more additional configurations, the particular percentage of policy needs that is to be allowed and/or developed during the particular time period may be determined automatically by the system based on the current workload and/or availability of development resources. For example, the system automatically may raise the second threshold in response to determining that few resources are available, and the system may lower the second threshold in response to determining that many resources are available.

In step 325, it may be determined whether each policy need is included in a third set of policy needs, where the third set of policy needs represents one or more policy needs not to be considered for development. According to one or more aspects, this determination may be based on the score for the policy need as determined in step 310. For example, it may be determined that a particular policy need is included in the third set of policy needs because the score for the policy need determined in step 310 does not exceed either the first threshold or the second threshold.

In step 330, a policy development report identifying the policy needs to be considered for development may be generated. For example, a policy development report may be generated, and the policy development report may include a pie chart with sections representing the one or more policy needs to be considered for immediate development, the one or more policy needs to be considered for later development, and/or the one or more policy needs not to be considered for development. Additionally or alternatively, the policy development report may include a detailed listing of policy needs, and the detailed listing of policy needs may include the audit issue closure date information, legal compliance information, regulatory impact information, customer severity impact information, financial impact information, and/or operational efficiency information for each policy need, along with the corresponding weights and the determined score for each policy need. Thus, the policy development report may assist an employee of a financial institution or other organization in confirming policy needs and/or in establishing a development prioritization. In other examples, a policy development report may be generated, and the policy development report may include sections representing the one or more policy needs to be considered for immediate development and the one or more policy needs to be considered for later development with no description of the one or more policy needs not to be considered for development.

FIG. 4 illustrates a sample user interface through which one or more policy needs may be assessed according to one or more aspects described herein. According to one or more aspects, the user interfaces described herein may be implemented by software executed on one or more computers, such as computing device 101, and/or in a network environment, such as network environment 200.

In one or more configurations, user interface 400 may include one or more pull-down menus, text boxes, and/or other form fields to facilitate the assessment of one or more policy needs. For example, user interface 400 may include data source pull-down menu 405, which may enable a user to specify the source of the information being entered into user interface 400. This source may be a particular database, report, or the like, and/or the source may be the user's own knowledge. In addition, user interface 400 may include report date pull-down menu 410, which may enable a user to specify a date associated with the information obtained from the data source. It may be preferable to receive the report date associated with the data source, as in an example where a particular policy need is based on a report having a particular date, the system optionally may use the report date to determine whether the report is out-of-date and thus whether the particular policy need is also out-of-date.

User interface 400 further may include issue name text box 415 in which a user may input an issue name and/or other identifier associated with a particular policy need. In addition, user interface 400 may include line of business pull-down menu 420, which may enable a user to select one or more lines of business within a financial institution and/or other organization that may be affected by the particular policy need. User interface 400 may also include issue description text box 425 in which a user may input a description of the issue associated with the particular policy need.

User interface 400 further may include audit issue closure date pull-down menu 430, which may enable a user to select an audit issue closure date for the particular policy need. As further described elsewhere herein, the audit issue closure date may represent the amount of time an entity, such as a financial institution, has to bring its practices and procedures into compliance with a new law or regulation related to a particular policy need. Thus, audit issue closure date pull-down menu 430 may have several options, including “Less Than 3 Months,” “More Than 3 Months,” “Pending,” and “Not Applicable.” In addition, user interface 400 may include audit issue closure date weight text box 435 in which a user may input a weight that may be used in determining a score for the particular policy need. In one or more configurations, a user might not be able to edit the contents of audit issue closure date weight text box 435, as the weight associated with the audit issue closure date may be predetermined

Additionally or alternatively, audit issue closure date pull-down menu 430 may have several options including specific dates and/or amounts of time in various units. For example, audit issue closure date pull-down menu 430 may have several options, including “Before Jan. 1, 2010,” “Between Jan. 1, 2010, and Jun. 30, 2010,” “Between Jul. 1, 2010, and Dec. 30, 2010,” “Between Jan. 1, 2011, and Jun. 30, 2011,” and “After Jun. 30, 2011.” In another example, audit issue closure date pull-down menu 430 may have several options, including “Within 12 Hours,” “Between 12 and 24 Hours,” “Between 1 day and 5 days,” “Between 5 days and 30 days,” and “More than 30 days.”

User interface 400 further may include legal compliance impact pull-down menu 440. As further described elsewhere herein, the legal compliance impact may represent the level of potential legal or regulatory impact that may result from non-compliance with a law or regulation related to a particular policy need. Thus, legal compliance impact pull-down menu 440 may have several options, including “Very High,” “High,” “Moderate,” “Low,” and “Very Low.” In addition, user interface 400 may include legal compliance impact weight text box 445 in which a user may input a weight that may be used in determining a score for the particular policy need. In one or more configurations, a user might not be able to edit the contents of legal compliance impact weight text box 445, as the weight associated with the legal compliance impact may be predetermined.

Additionally or alternatively, legal compliance impact pull-down menu 440 may have several options related to specific amounts of money associated with a potential penalty that may be imposed in the event of non-compliance. For example, legal compliance impact pull-down menu 440 may have several options, including “Less than $1 million dollars,” “$1 million dollars to $10 million dollars,” “$10 million dollars to $50 million dollars,” “$50 million dollars to $100 million dollars,” and “More than $100 million dollars.”

User interface 400 further may include regulatory impact pull-down menu 450. As further described elsewhere herein, the regulatory impact may represent the number of regulations addressed and/or affected by a particular policy need. Thus, regulatory impact pull-down menu 450 may have several options, including “One,” “Two,” “Three,” “Four,” and “Five or More.” In addition, user interface 400 may include regulatory impact weight text box 455 in which a user may input a weight that may be used in determining a score for the particular policy need. In one or more configurations, a user might not be able to edit the contents of regulatory impact weight text box 455 (and/or the contents of any of the other weight text boxes in user interface 400 further described below), as the weight associated with the regulatory impact may be predetermined.

Additionally or alternatively, regulatory impact pull-down menu 450 may have several options related to the degree to which a particular policy need addresses and/or affects one or more regulations. For example, regulatory impact pull-down menu 450 may have several options, including “1-2 regulations directly affected,” “3 or more regulations directly affected,” “1-2 regulations indirectly affected,” “3 or more regulations indirectly affected,” and “No regulations affected.”

User interface 400 further may include customer severity impact pull-down menu 460. As further described elsewhere herein, the customer severity impact may represent the level of potential impact on a customer experience that may result from non-compliance with a law or regulation. Thus, customer severity impact pull-down menu 460 may have several options, including “Very High,” “High,” “Moderate,” “Low,” and “Very Low.” In addition, user interface 400 may include customer severity impact weight text box 465 in which a user may input a weight that may be used in determining a score for the particular policy need. In one or more configurations, a user might not be able to edit the contents of customer severity impact weight text box 465, as the weight associated with the customer severity impact may be predetermined.

Additionally or alternatively, customer severity impact pull-down menu 460 may have several options related to one or more possible customer impact incidents. For example, customer severity impact pull-down may have several options, including “High visibility/Press coverage issue,” “Customer privacy issue,” “Information security issue,” “Customer website access issue,” and “No significant customer impact.”

User interface 400 further may include financial impact pull-down menu 470. As further described elsewhere herein, the financial impact may represent the level of potential financial impact that may result from implementing a policy in response to a particular policy need. Thus, financial impact pull-down menu 470 may have several options, including “Very High,” “High,” “Moderate,” “Low,” and “Very Low.” In addition, user interface 400 may include financial impact weight text box 475 in which a user may input a weight that may be used in determining a score for the particular policy need. In one or more configurations, a user might not be able to edit the contents of financial impact weight text box 475, as the weight associated with the financial impact may be predetermined

Additionally or alternatively, financial impact pull-down menu 470 may have several options related to specific amounts of money associated with the level of potential financial impact that may result from implementing a policy in response to a particular policy need. For example, financial impact pull-down menu 470 may have several options, including “Profit of more than $10 million dollars,” “Profit of $10 million dollars or less,” “No profit or loss,” “Loss of $10 million dollars or less,” and “Loss of more than $10 million dollars.”

User interface 400 further may include operational efficiency pull-down menu 480. As further described elsewhere herein, operational efficiency likelihood may represent the likelihood that a policy responding to a particular policy need will create one or more operational efficiency opportunities. Thus, operational efficiency pull-down menu 480 may have several options, including “Very Likely,” “Likely,” “Neutral,” “Unlikely,” and “Very Unlikely.” In addition, user interface 400 may include operational efficiency weight text box 485 in which a user may input a weight that may be used in determining a score for the particular policy need. In one or more configurations, a user might not be able to edit the contents of operational efficiency weight text box 485, as the weight associated with the operational efficiency likelihood may be predetermined

Additionally or alternatively, operational efficiency pull-down menu 480 may have several options related to specific types of operational efficiency opportunities that may result from the development and/or implementation of a policy in response to a particular policy need. Thus, operational efficiency pull-down menu 480 may have several options, including “Potential improvement of resource efficiency and/or realization,” “Potential reduction of errors in processes,” “Potential improvement in quality and/or timeliness of goods and/or services,” “Potential reduction of risk of future legal liabilities,” and “None.”

User interface 400 further may include project phase pull-down menu 490. Project phase pull-down menu 490 may have several options that may allow a user to indicate what phase a relevant project is in if the policy need involves a project. Thus, project phase pull-down menu 490 may have options such as “Not Applicable,” “Planning,” “Development,” “Implementation,” “Production,” and “Monitoring.” These options may correspond to one or more phases of a relevant project. For example, the “Planning” option may correspond to a planning phase of a relevant project, where one or more plans, goals, and/or timelines for the project are created. The “Development” option may correspond to a development phase of a relevant project, where one or more aspects of the project and/or its deliverables are developed. The “Implementation” option may correspond to an implementation phase of a relevant project, where one or more aspects of the project and/or its deliverables are implemented and/or deployed into an intended environment. The “Production” option may correspond to a production phase of a relevant project, which may follow the implementation phase of the relevant project, and where one or more aspects of the project and/or its deliverables have been implemented and/or deployed, and are now functioning in a final, production, and/or real-time environment. The “Monitoring” option may correspond to a monitoring phase of a relevant project, where one or more metrics are gathered with respect to one or more aspects of the project and/or its deliverables.

User interface 400 further may include several additional buttons, such as submit button 495 and reset button 497. By activating submit button 495, a user may trigger submission of the inputted data in the form fields of user interface 400. By activating reset button 497, a user may trigger the clearing of one or more of the form fields of user interface 400.

FIG. 5 illustrates a method by which a criticality rating and a complexity rating may be determined for a policy need according to one or more aspects described herein. In step 505, input may be received from a user, and the input may identify a first policy need. For example, a user may select the first policy need via a user interface and begin this determination process. Additionally or alternatively, input data may be extracted and/or received from one or more external databases.

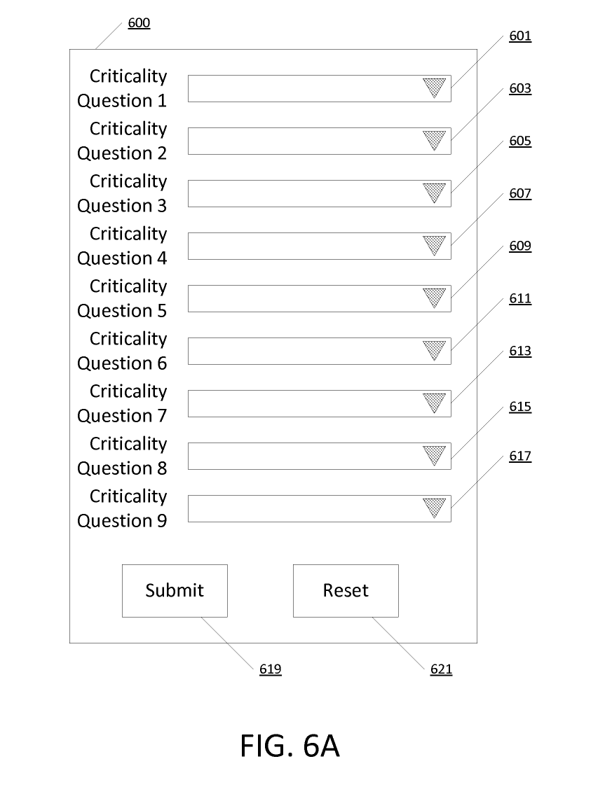

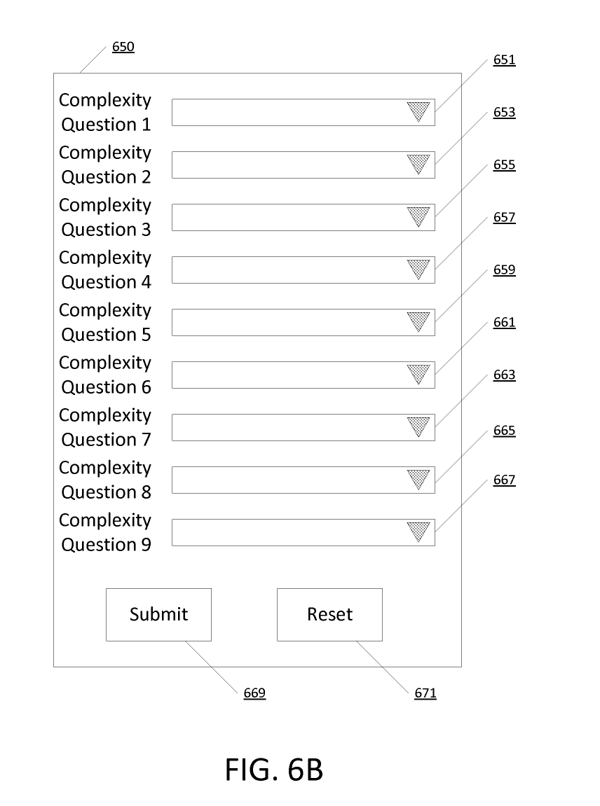

In step 510, a development criticality rating for the first policy need may be determined. According to one or more aspects, this development criticality rating may be based on one or more factors, such as whether the first policy need implicates an audit issue and/or whether the first policy need implicates a compliance issue. Additionally or alternatively, the development criticality rating may be based on information received via user interface 600, as further described with respect to FIG. 6A below.

In step 515, a development complexity rating for the first policy need may be determined According to one or more aspects, this development complexity rating may be based on one or more factors, such as the level of involvement required to develop the first policy need. This level of involvement may measure, for example, the involvement required by one or more subject matter experts and/or the involvement required by one or more policy development specialists. In this example, a subject matter expert may be a person who is familiar with one or more aspects of the field to be affected by a policy developed in response to the policy need (e.g., if the policy need relates to a digital information privacy issue, a subject matter expert may be a person who has specialized knowledge and/or concentrates in handling digital information privacy, such as a computer programmer or information technology executive). Also, in this example, a policy development specialist may be a person who has specialized knowledge and/or concentrates in developing policies related to a variety of different fields. Additionally or alternatively, the development complexity rating may be based on information received via user interface 650, as further described with respect to FIG. 6B below.

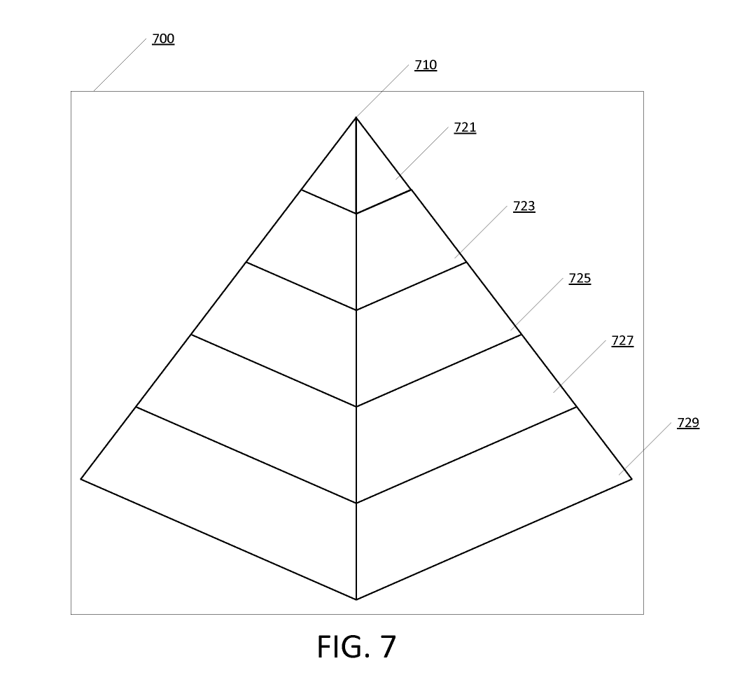

In step 520, a service level agreement for the first policy need may be generated based on the determined development complexity rating. According to one or more aspects, a classification system may be implemented in which one or more different complexity ratings correspond to one or more different lengths of time in which a policy should be developed. For example, with regard to a policy need that has a “Very High” development complexity rating, a service level agreement may be generated which indicates that policy development should take 150 days or more and/or which requires such development to be complete in such time. On the other hand, with regard to a policy need that has a “Very Low” development complexity rating, a service level agreement may be generated which indicates that policy development should take less than 59 days and/or which requires such development to be complete in such time. According to one or more additional aspects, a service level agreement for the first policy need may be generated based on a service level agreement pyramid 710, as further discussed with respect to FIG. 7 below.

In step 525, it may be determined whether more resources are required to develop the first policy need, and if it is determined that more resources are required to develop the first policy need, a request for more resources may be triggered accordingly. Resources may include human resources (i.e., one or more people), money, machines and/or hardware (e.g., computers), software, and/or real estate (e.g., office space, warehouses, buildings, and/or land). According to one or more aspects, it may be determined, based on information stored in a database regarding the workload and capacity of one or more policy development resources, whether more policy development resources are required to develop the first policy need. For example, a computer may evaluate whether more policy development resources are required to develop the first policy need. This evaluation may include retrieving resource information from one or more databases, determining, based on the current resource workload and current resource capacity as indicated by the retrieved resource information, the amount of available development power, determining, based on the development complexity rating for the first policy need and/or other information about the first policy need, the amount of development power required to develop the first policy need, and determining, based on the amount of available development power and on the amount of development power required to develop the first policy need, whether more resources are required to develop the first policy need. According to one or more additional aspects, a request for more resources may be triggered only for a policy need having at least a high development criticality rating. In other words, in at least one additional aspect, a request for more resources might not be triggered for a policy need having a only a moderate or lower development criticality rating.

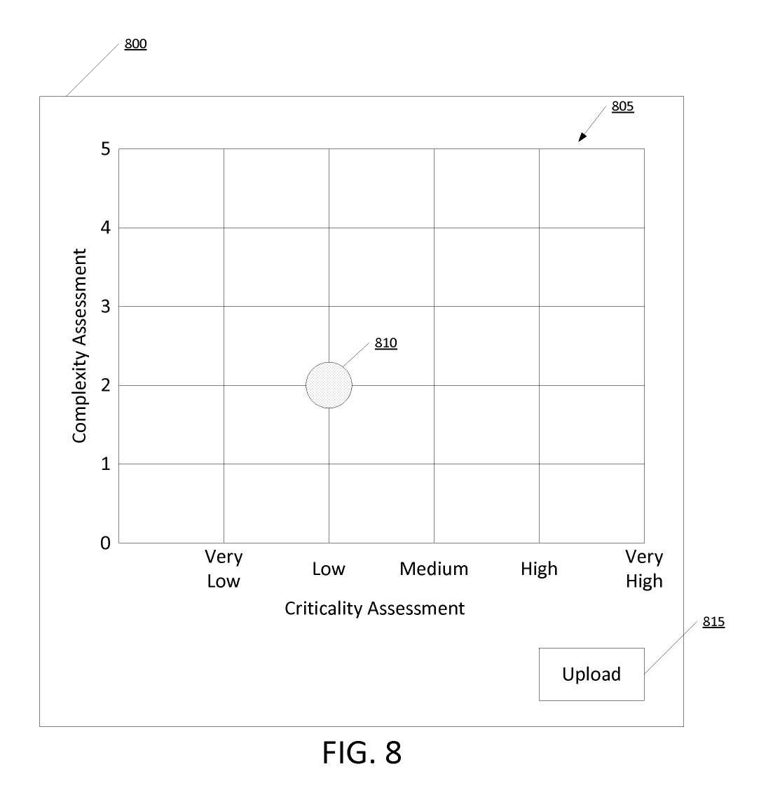

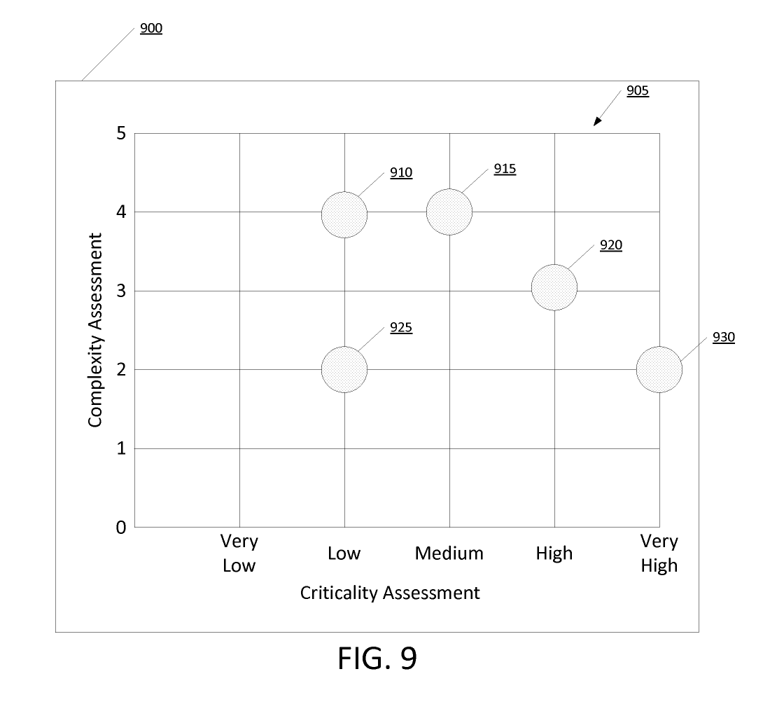

In step 530, a report may be generated. According to one or more aspects, the report may include one or more graphs that may facilitate prioritizing development of one or more policy needs. For example, a report may be generated that includes criticality and complexity graph 805, as further discussed with respect to FIG. 8 below, and/or a portfolio-level criticality and complexity graph 905, as further discussed with respect to FIG. 9 below. In accordance with at least one aspect, a user may use criticality and complexity graph 805 and/or portfolio-level criticality and complexity graph 905 in prioritizing development of one or more policy needs. Additionally or alternatively, one or more computers may prioritize development of one or more policy needs, and the report generated in 530 may include criticality and complexity graph 805 and/or portfolio-level criticality and complexity graph 905 to present the results of such computerized development prioritization.

FIG. 6A illustrates a sample user interface through which a criticality rating may be determined for a policy need according to one or more aspects described herein. In one or more configurations, user interface 600 may include one or more pull-down menus, text boxes, and/or other form fields to facilitate the determination of a criticality rating for a policy need. For example, user interface 600 may include one or more criticality questions and/or one or more pull-down menus to facilitate the collection of information that may bear on the determination of a criticality rating for a policy need.

Thus, user interface 600 may include a first criticality question and associated pull-down menu 601. In one or more arrangements, the first criticality question may be directed to whether the policy need is driven by an audit issue.

User interface 600 further may include a second criticality question and associated pull-down menu 603. In one or more arrangements, the second criticality question may be directed to the likelihood that a policy developed in response to the policy need will address concerns related to violations of laws, rules, or regulations, or will address concerns related to non-conformance with other policies, procedures, or ethical standards.

User interface 600 further may include a third criticality question and associated pull-down menu 605. In one or more arrangements, the third criticality question may be directed to the likelihood that a policy developed in response to the policy need will address concerns related to adverse profitability and/or balance sheet issues.

User interface 600 further may include a fourth criticality question and associated pull-down menu 607. In one or more arrangements, the fourth criticality question may be directed to the likelihood that a policy developed in response to the policy need will address concerns related to adverse business decisions and/or improper implementation of business decisions.

User interface 600 further may include a fifth criticality question and associated pull-down menu 609. In one or more arrangements, the fifth criticality question may be directed to the likelihood that a policy developed in response to the policy need will address concerns related to problems with technology, operational capacity, and/or customer demands.

User interface 600 further may include a sixth criticality question and associated pull-down menu 611. In one or more arrangements, the sixth criticality question may be directed to the likelihood that a policy developed in response to the policy need will address concerns related to the processing and/or delivery of business needs in an effective and/or efficient manner.

User interface 600 further may include a seventh criticality question and associated pull-down menu 613. In one or more arrangements, the seventh criticality question may be directed to the likelihood that a policy developed in response to the policy need will be a process that primarily will be managed by a third party or outside vendor.

User interface 600 further may include an eighth criticality question and associated pull-down menu 615. In one or more arrangements, the eighth criticality question may be directed to the likelihood that a policy developed in response to the policy need will address concerns related to management instability, turnover, organizational structure, and/or other human resources.

User interface 600 further may include a ninth criticality question and associated pull-down menu 617. In one or more arrangements, the ninth criticality question may be directed to the likelihood that a policy developed in response to the policy need will address concerns related to adverse impact by external factors not controlled by the organization implementing the policy.

User interface 600 further may include several buttons, such as submit button 619 and reset button 621. By activating submit button 619, a user may trigger submission of the inputted data in the form fields of user interface 600. By activating reset button 621, a user may trigger the clearing of one or more of the form fields of user interface 600.

FIG. 6B illustrates a sample user interface through which a complexity rating may be determined for a policy need according to one or more aspects described herein. In one or more configurations, user interface 650 may include one or more pull-down menus, text boxes, and/or other form fields to facilitate the determination of a complexity rating for a policy need. For example, user interface 650 may include one or more complexity questions and/or one or more pull-down menus to facilitate the collection of information that may bear on the determination of a complexity rating for a policy need.

Thus, user interface 650 may include a first complexity question and associated pull-down menu 651. In one or more arrangements, the first complexity question may be directed to the level of involvement a subject matter expert and/or other person will have in formulating a policy developed in response to the policy need.

User interface 650 further may include a second complexity question and associated pull-down menu 653. In one or more arrangements, the second complexity question may be directed to the likelihood that a policy developed in response to the policy need will require a cultural shift in thinking and/or behavior.

User interface 650 further may include a third complexity question and associated pull-down menu 655. In one or more arrangements, the third complexity question may be directed to the likelihood that a policy developed in response to the policy need will require a technological solution.

User interface 650 further may include a fourth complexity question and associated pull-down menu 657. In one or more arrangements, the fourth complexity question may be directed to the estimated amount of time which may be required to develop the technology to support a policy developed in response to the policy need.

User interface 650 further may include a fifth complexity question and associated pull-down menu 659. In one or more arrangements, the fifth complexity question may be directed to the likelihood that a policy developed in response to the policy need will implicate legal, regulatory, and/or other compliance concerns.

User interface 650 further may include a sixth complexity question and associated pull-down menu 661. In one or more arrangements, the sixth complexity question may be directed to the likelihood that a policy developed in response to the policy need will implicate audit concerns.

User interface 650 further may include a seventh complexity question and associated pull-down menu 663. In one or more arrangements, the seventh complexity question may be directed to the estimated number of lines of business that may be affected by a policy developed in response to the policy need within an organization implementing the policy.

User interface 650 further may include an eighth complexity question and associated pull-down menu 665. In one or more arrangements, the eighth complexity question may be directed to the likelihood that a policy developed in response to the policy need will require more resources to develop, implement, and/or maintain the policy.

User interface 650 further may include a ninth complexity question and associated pull-down menu 667. In one or more arrangements, the ninth complexity question may be directed to the level to which monitoring and/or control processes, related to a policy developed in response to the policy need, are established.

User interface 650 further may include several buttons, such as submit button 669 and reset button 671. By activating submit button 669, a user may trigger submission of the inputted data in the form fields of user interface 650. By activating reset button 671, a user may trigger the clearing of one or more of the form fields of user interface 650.

FIG. 7 illustrates a sample user interface in which a complexity rating may be correlated with a development time for a policy need according to one or more aspects described herein. In one or more configurations, user interface 700 may include a service level agreement pyramid 710 which may be used in determining a service level agreement for a particular policy need based on the development complexity rating for the particular policy need. For example, service level agreement pyramid 710 may include one or more complexity levels 721, 723, 725, 727, and 729. In at least one configuration, complexity level 721 at the top of service level agreement pyramid 710 may represent the highest level of complexity and thus may correspond to the highest complexity rating and, thus, the longest development time. Complexity level 723 may represent the second highest level of complexity and thus may correspond to the second highest complexity rating and the second longest development time. Complexity level 725 may represent the third highest level of complexity and thus may correspond to the third highest complexity rating and the third longest development time. Complexity level 727 may represent the second lowest level of complexity and thus may correspond to the second lowest complexity rating and the second shortest development time. Complexity level 729 may represent the lowest level of complexity and thus may correspond to the lowest complexity rating and the shortest development time.

In accordance with at least one aspect, development time may be measured in a number of days. In addition, according to one or more aspects, a user may utilize service level agreement pyramid 710 to correlate one or more complexity ratings with one or more development times in determining one or more service level agreements for one or more policy needs. Additionally or alternatively, a computer may determine a complexity rating for a policy need, and the computer subsequently may determine a service level agreement for the policy need based on the determined complexity rating. Thereafter, the computer may generate and/or display service level agreement pyramid 710, and this may provide a user with a visual depiction of the determined service level agreement for the policy need.

FIG. 8 illustrates a sample user interface in which a criticality rating and a complexity rating of a policy need may be compared according to one or more aspects described herein. In one or more configurations, user interface 800 may include a criticality and complexity graph 805. Criticality and complexity graph 805 may plot the complexity rating for a particular policy need against the criticality rating for the particular policy need in order to present a visual depiction of the criticality rating and the complexity rating for the particular policy need. For example, an example policy need 810 having a complexity rating of “2” and a criticality rating of “low” may be plotted on criticality and complexity graph 805 as seen in FIG. 8.

In one or more additional configurations, user interface 800 may include upload button 815. By activating upload button 815, a user may cause the criticality and complexity data for the currently plotted policy need to be uploaded to a central policy development computer and/or website. Subsequently, the criticality and complexity data for the uploaded policy need may be plotted in a portfolio-level criticality and complexity graph, such as portfolio-level criticality and complexity graph 905, as further discussed with respect to FIG. 9.

FIG. 9 illustrates a sample user interface in which a criticality rating and a complexity rating of one or more policy needs may be compared according to one or more aspects described herein. In one or more configurations, user interface 900 may include portfolio-level criticality and complexity graph 905. According to one or more aspects, portfolio-level criticality and complexity graph 905 may plot the complexity rating for one or more policy needs against the corresponding criticality ratings in order to present a visual depiction of the criticality ratings and complexity ratings of one or more policy needs in a particular portfolio of policy needs. For example, portfolio-level criticality and complexity graph 905 may include plots of one or more policy needs, such as example policy needs 910, 915, 920, 925, and 930.

In one or more arrangements, it may be desirable to determine and/or compare a criticality rating and a complexity rating for each of the one or more policy needs in a particular portfolio of policy needs. More specifically, by comparing the criticality ratings of each of the one or more policy needs in the particular portfolio of policy needs, a user may be able to prioritize each of the one or more policy needs. For example, a user may prioritize a first policy need with a relatively high criticality rating over a second policy need with a relatively low criticality rating. In addition, by determining the complexity ratings of each of the one or more policy needs in the particular portfolio of policy needs, a user may be able to determine the amount of time that may be required to develop each of the one or more policy needs. Thus, by considering both the criticality rating and the complexity rating of each of the one or more policy needs in the particular portfolio of policy needs, a user and/or the system may be able allocate development and/or management resources in an optimally efficient and/or effective manner.

According to one or more aspects, a user may utilize portfolio-level criticality and complexity graph 905 in prioritizing development of one or more policy needs. For example, in view of example policy needs 910, 915, 920, 925, and 930 as plotted on portfolio-level criticality and complexity graph 905 in FIG. 9, a user may decide to develop policy need 930 before policy need 920 because policy need 930 is lower and farther to the right in portfolio-level criticality and complexity graph 905 than policy need 920, thus indicating that policy need 930 is more critical and less complex than policy need 920. Additionally or alternatively, a computer may recommend, determine, and/or decide the order in which the one or more policy needs should be developed. Thus, according to at least one aspect, one policy need may be developed before another policy need is developed because the former is more critical and/or less complex.

According to one or more additional aspects, a less critical and/or more complex policy need might be developed before another, more critical and/or less complex, policy need. For example, a user and/or a computer may determine that a less critical and/or more complex policy need should be developed before another, more critical and/or less complex, policy need because the resources required to develop the less critical and/or more complex policy need are available, while the resources required to develop the more critical and/or less complex policy need are unavailable.

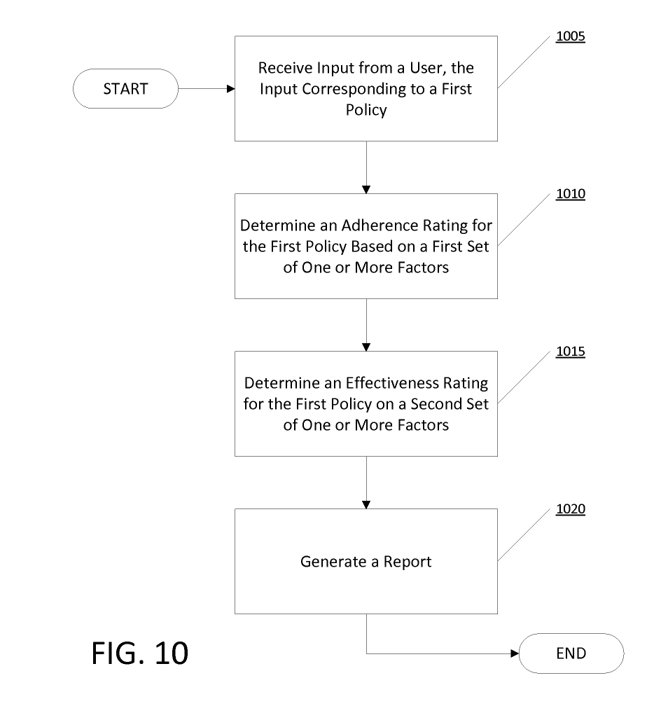

FIG. 10 illustrates a method by which an adherence rating and an effectiveness rating may be determined for a policy according to one or more aspects described herein. In step 1005, input may be received from a user, and the input may correspond to a first policy. For example, a user may input data using one or more of the user interfaces described herein. Additionally or alternatively, input data may be extracted and/or received from one or more external databases.

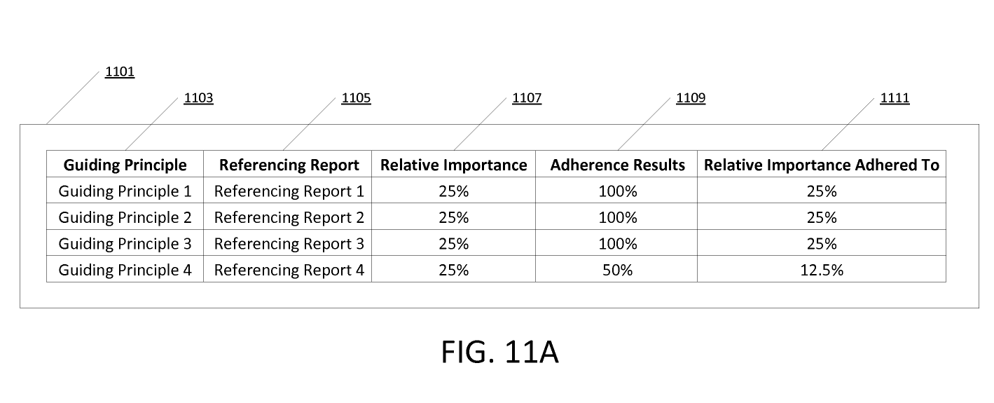

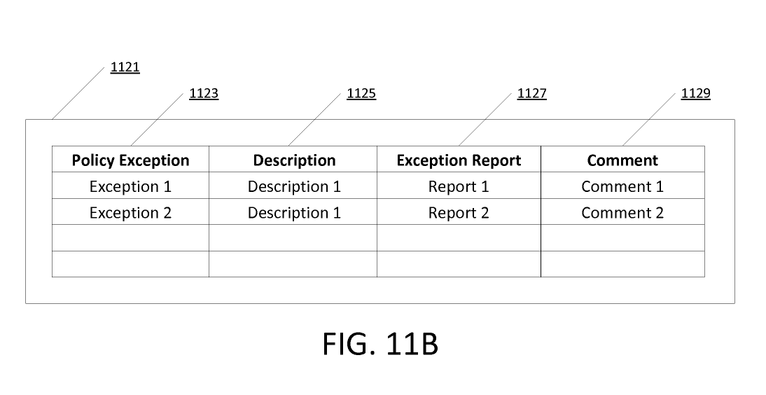

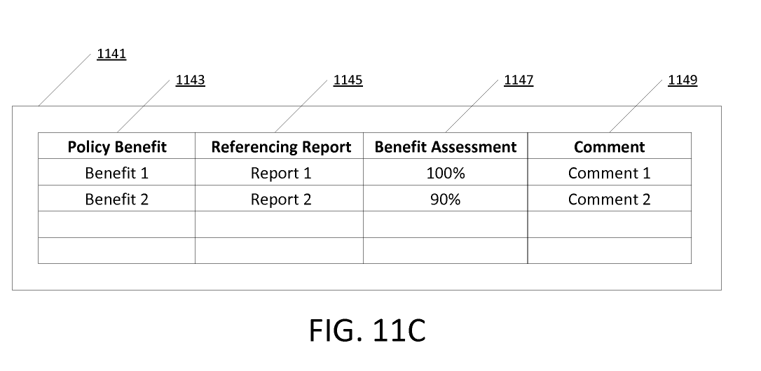

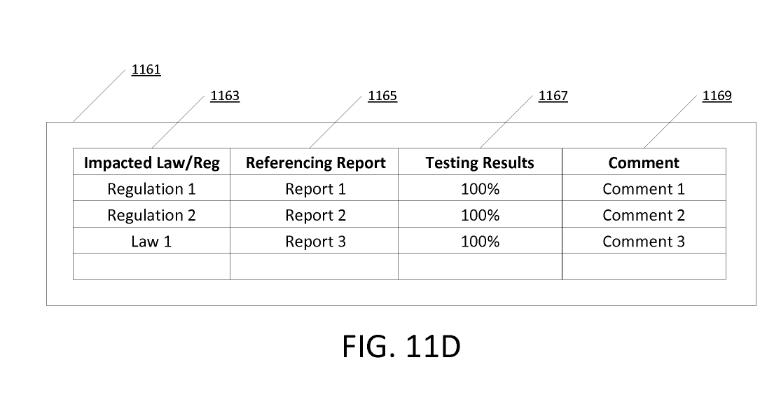

In step 1010, an adherence rating for the first policy may be determined based on a first set of one or more factors. According to one or more aspects, the first set of factors may include a measured level of compliance with each of one or more guiding principles underlying the first policy and/or a determined level of relative importance of each of the guiding principles underlying the first policy. For example, the one or more guiding principles underlying the first policy may be considered separately, a level of relative importance may be assigned and/or determined with respect to each guiding principle, and a level of compliance with respect to each guiding principle may be measured and/or otherwise determined Subsequently, a relative adherence score may be computed for each guiding principle underlying the first policy and/or for the first policy as a whole, and the results may be displayed in and/or reported via a user interface, such as user interface 1101, which is further described with respect to FIG. 11A below.

In step 1015, an effectiveness rating for the first policy may be determined based on a second set of one or more factors. According to one or more aspects, the second set of factors may include a determined level of responsiveness for the first policy, a determined level of business operational impact for the first policy, and/or a determined level of compliance with laws and regulations relevant to the first policy.

According to one or more additional aspects, the level of responsiveness for the first policy may be determined based on the number of exceptions to the first policy that have been created. For example, if a first example policy has three exceptions and a second example policy has only one exception, then the second example policy is more responsive than the first example policy because fewer exceptions have had to be created to align the second example policy with its underlying policy need as compared to the first example policy. Additionally or alternatively, each of the one or more exceptions to the first policy, if there are any exceptions to the first policy at all, may be displayed in and/or reported via a user interface, such as user interface 1121, which is further described with respect to FIG. 11B below.

According to one or more additional aspects, the level of business operational impact for the first policy may be determined based on the extent to which the first policy is providing one or more benefits which it may have been expected to provide. For example, the one or more expected benefits of the first policy may be considered separately, the extent to which the first policy is providing each benefit may be assessed, an average of the assessed benefit values may be computed, and the average may represent the level of business operational impact for the first policy. Subsequently, each assessment and/or the determined level of business operational impact for the first policy may be displayed in and/or reported via a user interface, such as user interface 1141, which is further described with respect to FIG. 11C below.

According to one or more additional aspects, the level of compliance with laws and regulations relevant to the first policy may be determined based on one or more compliance testing results. For example, the one or more laws and/or regulations relevant to the first policy may be considered separately, the extent to which the first policy complies with each law and/or regulation may be assessed, an average of the assessed compliance values may be computed, and the average may represent the level of compliance with laws and regulations relevant to the first policy for the first policy. Subsequently, each assessment and/or the determined level of compliance with laws and regulations relevant to the first policy may be displayed in and/or reported via a user interface, such as user interface 1161, which is further described with respect to FIG. 11D below.

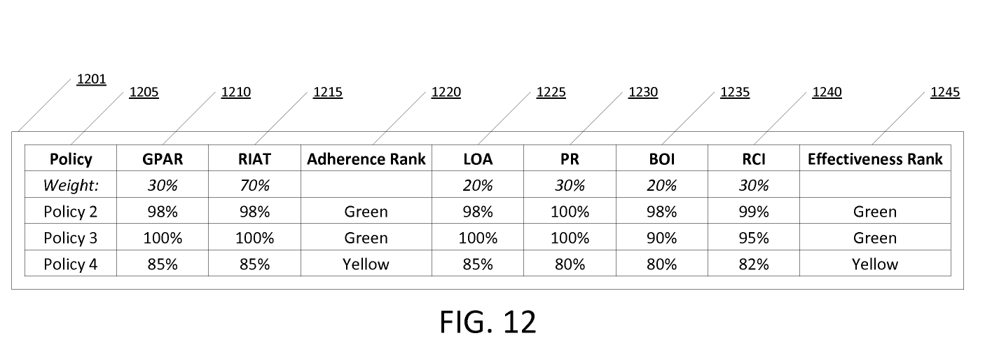

In step 1020, a report may be generated. According to one or more aspects, the report may include the determined adherence rating and the determined effectiveness rating for the first policy. Additionally or alternatively, the report may include other information about the first policy and/or information about one or more other policies to facilitate the comparison of the first policy with the one or more other policies. For example, for each policy in the report, the report may include the name of the policy; the measured level of compliance with each of the one or more guiding principles underlying the policy; the determined level of relative importance of each of the guiding principles underlying the policy; a weighted adherence score based on a weighted sum of the measured level of compliance and the determined level of relative importance of each of the one or more guiding principles underlying the policy; and/or the determined adherence rating of the policy. In addition, for each policy in the report, the report may include the determined level of responsiveness for the policy; the determined level of business operational impact for the policy; the determined level of compliance with laws and regulations relevant to the policy; a weighted effectiveness score based on a weighted sum of the determined level of responsiveness, the determined level of business operational impact, and the determined level of compliance with laws and regulations relevant to the policy; and/or the determined effectiveness rating of the policy. Additionally or alternatively, such a report may be displayed in and/or reported via a user interface, such as user interface 1201, which is further described with respect to FIG. 12 below.

According to one or more additional aspects, the report may categorize the one or more policies contained therein based on their respective adherence rating and/or effectiveness rating. According to at least one additional aspect, the report may include an action plan, test frequency information, and/or a next review date for each of the one or more policies contained in the report. For example, the report may include an action plan that sets forth corrective action to be taken to improve the adherence rating and/or effectiveness rating of a particular policy, test frequency information that provides how often the adherence rating and/or effectiveness rating of the particular policy should be reevaluated, and/or a next review date that indicates when the adherence rating and/or effectiveness rating of the particular policy will be reevaluated.

FIG. 11A illustrates a sample user interface through which an adherence rating may be determined for a policy according to one or more aspects described herein. In one or more configurations, user interface 1101 may include a table with one or more columns, such as guiding principles column 1103, referencing report column 1105, relative importance column 1107, adherence results column 1109, and/or relative importance adhered to column 1111.

According to one or more aspects, user interface 1101 may be used to display and/or report information related to determining an adherence rating for a first policy, as further described with respect to FIG. 10. For example, guiding principles column 1103 may list the one or more guiding principles underlying the first policy, and this arrangement may allow each guiding principle to be separately considered and/or accounted for. Referencing report column 1107 may list one or more referencing reports that may form the basis for determining policy adherence results. Relative importance column 1107 may list one or more levels of relative importance that may be assigned and/or determined for each guiding principle. Adherence results column 1109 may list one or more levels of compliance that may be determined for each guiding principle. Relative importance adhered to column 1111 may list one or more relative adherence scores that may be determined for each guiding principle based on the relative importance and/or adherence results of each guiding principle.

FIG. 11B illustrates a sample user interface through which a responsiveness rating may be determined for a policy according to one or more aspects described herein. In one or more configurations, user interface 1121 may include a table with one or more columns, such as policy exception column 1123, description column 1125, exception report column 1127, and/or comment column 1129.

According to one or more aspects, user interface 1121 may be used to display and/or report information related to determining an effectiveness rating for a first policy, as further described with respect to FIG. 10. For example, policy exception column 1123 may list one or more policy exceptions for the first policy, and this arrangement may allow a level of responsiveness to be determined and/or evaluated for the first policy. Description column 1125 may list one or more descriptions for each of the one or more policy exceptions for the first policy, and thus may allow a user to view more details about each policy exception and/or evaluate each policy exception. Exception report column 1127 may list one or more exception reports that may form the basis for determining the level of responsiveness for the first policy. Comment column 1129 may list one or more comments for each of the one or more policy exceptions for the first policy, and thus may allow a user to view more details about each policy exception and/or evaluate each policy exception.

FIG. 11C illustrates a sample user interface through which a business operational impact rating may be determined for a policy according to one or more aspects described herein. In one or more configurations, user interface 1141 may include a table with one or more columns, such as policy benefit column 1143, referencing report column 1145, benefit assessment column 1147, and/or comment column 1149.

According to one or more aspects, user interface 1141 may be used to display and/or report information related to determining an effectiveness rating for a first policy, as further described with respect to FIG. 10. For example, policy benefit column 1143 may list one or more expected benefits for the first policy, and this arrangement may allow the one or more expected benefits for the first policy to be separately considered and/or accounted for. Referencing report column 1145 may list one or more referencing reports that may form the basis for determining policy effectiveness results. Benefit assessment column 1147 may list the extent to which the first policy is providing each expected benefit, which may allow a level of business operational impact to be determined and/or evaluated for the first policy. Comment column 1149 may list one or more comments for each of the one or more expected benefits for the first policy, and thus may allow a user to view more details about each expected benefit and/or evaluate each expected benefit.

FIG. 11D illustrates a sample user interface through which a compliance rating may be determined for a policy according to one or more aspects described herein. In one or more configurations, user interface 1161 may include a table with one or more columns, such as impacted law or regulation column 1163, referencing report column 1165, testing results column 1167, and/or comment column 1169.

According to one or more aspects, user interface 1161 may be used to display and/or report information related to determining an effectiveness rating for a first policy, as further described with respect to FIG. 10. For example, impacted law or regulation column 1163 may list one or more laws and/or regulations relevant to the first policy, and this arrangement may allow the one or more laws and/or regulations to be separately considered and/or accounted for. Referencing report column 1165 may list one or more referencing reports that may form the basis for determining policy effectiveness results. Testing results column 1167 may list one or more compliance values for each of the one or more laws and/or regulations relevant to the first policy, which may allow a user to view and/or evaluate a determined level of compliance with laws and regulations relevant to the first policy. Comment column 1169 may list one or more comments for each of the one or more laws and/or regulations relevant to the first policy, and thus may allow a user to view more details about each law and/or regulation and/or evaluate each law and/or regulation.

FIG. 12 illustrates a sample user interface through which one or more policies may be compared according to one or more aspects described herein. In one or more configurations, user interface 1201 may include a table with one or more columns, such as policy name column 1205, guiding principle adherence results column 1210, relative importance adhered to column 1215, adherence rank column 1220, level of adherence column 1225, policy responsiveness column 1230, business operational impact column 1235, regulatory and compliance impact column 1240, and/or effectiveness rank column 1245. In at least one configuration, one or more of the columns in the table may include a weight value, which may be applied to the other values in that column in computing and/or displaying the adherence rating and/or the effectiveness rating for each policy.

According to one or more aspects, user interface 1201 may be used to display and/or report portfolio-level information about one or more policies to facilitate comparison and/or evaluation of the one or more policies, as further described with respect to FIG. 10. For example, policy name column 1205 may list a name for each of one or more policies being analyzed and/or evaluated. Guiding principle adherence results column 1210 may list, for each policy in the table, a level of compliance with all of the one or more guiding principles underlying the policy. Relative importance adhered to column 1215 may list a relative adherence score for each policy in the table. Adherence rank column 1220 may list an adherence rating for each policy in the table and/or a classification, numerical score, and/or numerical rank for each policy in the table. Level of adherence column 1225 may list a weighted adherence score for each policy in the table, and this weighted adherence score may be computed based on the guiding principle adherence results and the relative importance adhered to for each policy, along with the assigned weights for the guiding principle adherence results column 1210 and relative importance adhered to column 1215. Policy responsiveness column 1230 may list, for each policy in the table, a determined level of responsiveness for the policy. Business operational impact column 1235 may list a determined level of business operational impact for each policy in the table. Regulatory and compliance impact column 1240 may list, for each policy listed in the table, a determined level of compliance with laws and/or regulations relevant to each policy. Effectiveness rank column 1245 may list an effectiveness rating for each policy in the table and/or a classification, numerical score, and/or numerical rank for each policy in the table.

Although not required, one of ordinary skill in the art will appreciate that various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A method, comprising:
receiving, at a computer, input corresponding to a first policy need;
determining, on the computer, based on whether the first policy need implicates an audit issue and based on whether the first policy need implicates a compliance issue, a development criticality rating for the first policy need;
determining, on the computer, based on a level of involvement required to develop the first policy need, a development complexity rating for the first policy need; and
generating, on the computer, a report, the report including the development criticality rating for the first policy need and the development complexity rating for the first policy need.

2. The method of claim 1, wherein receiving input includes receiving stored information from at least one external database.

3. The method of claim 1, wherein determining a development criticality rating for the first policy need is further based on whether the first policy need relates to improving profitability, whether the first policy need relates to preventing adverse business decisions, whether the first policy need relates to improving operational capacity, and whether developing the first policy need involves an external resource.

4. The method of claim 1, wherein determining a development complexity rating is further based on whether implementing the first policy need involves a cultural shift, whether implementing the first policy need involves a technological solution, whether the first policy need relates to a compliance issue, and whether the first policy need relates to an audit issue.

5. The method of claim 1, wherein determining a development complexity rating is further based on an estimated amount of time needed for developing technology related to the first policy need.

6. The method of claim 1, wherein the report includes a graph, the graph plotting the development complexity rating against the development criticality rating for the first policy need and at least one additional policy need.

7. The method of claim 1, further comprising:
generating, on the computer, a service level agreement based on the determined development complexity rating.

8. The method of claim 1, further comprising:
in response to determining that the development criticality rating for the first policy need is high, triggering, on the computer, a request for more development resources.

9. One or more computer-readable media having computer-executable instructions stored thereon, that when executed by one or more computers, cause the one or more computers to perform:
receiving input corresponding to a first policy need;
determining, based on whether the first policy need implicates an audit issue and based on whether the first policy need implicates a compliance issue, a development criticality rating for the first policy need;
determining, based on a level of involvement required to develop the first policy need, a development complexity rating for the first policy need; and
generating a report, the report including the development criticality rating for the first policy need and the development complexity rating for the first policy need.

10. The computer-readable media of claim 9, wherein receiving input includes receiving stored information from at least one external database.

11. The computer-readable media of claim 9, wherein determining a development criticality rating for the first policy need is further based on whether the first policy need relates to improving profitability, whether the first policy need relates to preventing adverse business decisions, whether the first policy need relates to improving operational capacity, and whether developing the first policy need involves an external resource.

12. The computer-readable media of claim 9, wherein determining a development complexity rating is further based on whether implementing the first policy need involves a cultural shift, whether implementing the first policy need involves a technological solution, whether the first policy need relates to a compliance issue, and whether the first policy need relates to an audit issue.

13. The computer-readable media of claim 9, wherein determining a development complexity rating is further based on an estimated amount of time needed for developing technology related to the first policy need.

14. The computer-readable media of claim 9, wherein the report includes a graph, the graph plotting the development complexity rating against the development criticality rating for the first policy need and at least one additional policy need.

15. The computer-readable media of claim 9, having additional computer-executable instructions stored thereon, that when executed by a computer, cause the computer to perform:
generating a service level agreement based on the determined development complexity rating.

16. The computer-readable media of claim 9, having additional computer-executable instructions stored thereon, that when executed by a computer, cause the computer to perform:
in response to determining that the development criticality rating for the first policy need is high, triggering a request for more development resources.

17. An apparatus, comprising:
a processor; and
memory storing computer-readable instructions that, when executed by the processor, cause the apparatus to perform:
receiving input corresponding to a first policy need;
determining, based on whether the first policy need implicates an audit issue and based on whether the first policy need implicates a compliance issue, a development criticality rating for the first policy need;
determining, based on a level of involvement required to develop the first policy need, a development complexity rating for the first policy need; and
generating a report, the report including the development criticality rating for the first policy need and the development complexity rating for the first policy need.

18. The apparatus of claim 17, wherein receiving input includes receiving stored information from at least one external database.

19. The apparatus of claim 17, wherein determining a development criticality rating for the first policy need is further based on whether the first policy need relates to improving profitability, whether the first policy need relates to preventing adverse business decisions, whether the first policy need relates to improving operational capacity, and whether developing the first policy need involves an external resource.

20. The apparatus of claim 17, wherein determining a development complexity rating is further based on whether implementing the first policy need involves a cultural shift, whether implementing the first policy need involves a technological solution, whether the first policy need relates to a compliance issue, and whether the first policy need relates to an audit issue.

21. The apparatus of claim 17, wherein determining a development complexity rating is further based on an estimated amount of time needed for developing technology related to the first policy need.

22. The apparatus of claim 17, wherein the report includes a graph, the graph plotting the development complexity rating against the development criticality rating for the first policy need and at least one additional policy need.

23. The apparatus of claim 17, the memory further storing computer-readable instructions that, when executed by the processor, cause the apparatus to perform:
generating a service level agreement based on the determined development complexity rating.

24. The apparatus of claim 17, the memory further storing computer-readable instructions that, when executed by the processor, cause the apparatus to perform:
in response to determining that the development criticality rating for the first policy need is high, triggering a request for more development resources.
